(19) United States
(12) Patent Application Publication
(10) Pub. No.: US 2004/0145965 A1
(43) Pub. Date: Jul. 29, 2004

(54) Mixing cooker

(75) Inventors: Joey Wing Po Chan, Tsuen Wan (HK); Kim Ming Wong, Fanling (HK); Phillip William Keem, Tai Po (HK)

Correspondence Address: LEYDIG VOIT & MAYER, LTD, 700 THIRTEENTH ST. NW, SUITE 300, WASHINGTON, DC, 20005-3960, US

(73) Assignee: Chiaphua Industries Limited, Tai Po (HK)

(21) Appl. No.: 10/353,089

(22) Filed: Jan. 29, 2003

(51) Int. Cl. B01F 7/18

(52) U.S. Cl. 366/197; 366/326.1

(57) ABSTRACT

An apparatus for stirring ingredients includes a base, a receptacle supported by the base for receiving the ingredients, a track mounted to the base, a carriage conveyed along the track, an arm extending from the carriage over the receptacle, and a driven paddle depending from the arm into the receptacle. The apparatus and also include a heater supported by the base for heating the receptacle. The paddle can be specially configured to include a bridge and a pair of blades attached pivotally to the bridge. The blades can yield, should they encounter a hard ingredients in use.

### BACKGROUND OF THE INVENTION

The present invention relates to mixers and mixing cookers. More particularly, although not exclusively, the invention relates to a cooker having rotational mixing paddles driven to traverse back and forth within a mixing receptacle and to “Yield”, should they encounter a hard object.

Food mixers of various forms are known. These are mostly used for mixing food ingredients prior to cooking. For example cake mixers commonly employ a circular mixing bowl with beaters depending from an overhead assembly and extending into the bowl. The beaters usually rotate about fixed axes, but might also more in an orbital fashion.

Some automated cooking devices apply cooking heat to a receptacle and also provide a continuous stirring action to the contents of the receptacle. In all such known devices, the mixing bowl or cooking receptacle is circular, and this does not represent efficient utilisation of kitchen bench space.

Mixing and stirring devices have rigidly mounted stirring paddles, beaters or blades. If such paddles, beaters or blades are used to stir or mix a cooking casserole for example, they might encounter bones or other hard ingredients and jam, causing possible damage to the driving motor and related mechanisms.

### OBJECTS OF THE INVENTION

It is an object of the present invention to overcome or substantially ameliorate at least one of the above disadvantages/limitations and/or more generally to provide an improved cooking/stirring apparatus.

### DISCLOSURE OF THE INVENTION

There is disclosed herein an apparatus for stirring ingredients, comprising:

a base,

a receptacle supported by the base for receiving the ingredients,

a track mounted to the base,

a carriage conveyed along the track,

an arm extending from the carriage over the receptacle, and

a driven paddle depending from the arm into the receptacle.

Preferably the carriage is pivotable upon the track.

Preferably the apparatus further includes a carriage motor and the track comprises a pair of elongate parallel and substantially coextensive rails passing through corresponding apertures in the carriage and there is an elongate worm parallel with the rails and driven to rotate by the carriage motor and the carriage comprises a worm follower engaging with the worm.

Preferably the worm comprises a helical thread with which the worm follower engages.

Optionally rotational output of the carriage motor reverses.

Alternatively the carriage motor rotates in one direction only and the helical thread of the worm reverses and crisscrosses upon itself.

The apparatus preferably comprises a paddle motor in the arm driving the paddle.

The apparatus preferably includes a further paddle also driven by the paddle motor.

Preferably both said paddles are substantially identical and overlap with one another.

The receptacle is preferably substantially rectangular when viewed in plan, hut with curved corners to accommodate the paddles.

The paddles preferably comprise a bridge extending diametrically from a vertical shaft and from which a pair of blades depend.

Each blade is preferably attached pivotally to the bridge.

Each blade might be snap-engaged to the bridge.

Preferably the blades are adapted to pivot toward one another.

The blades are preferably spring-biased toward an in-use configuration.

The blades typically comprise an integral leaf spring that bears against the bridge.

One of said paddles typically extends from a gear driven by an output gear of the paddle motor and the other paddle extends from a gear and wherein there is a gear train between these two gears.

Preferably a heater heats the receptacle and is supported by the base.

There is further disclosed herein a stirring paddle for a food stirring apparatus, comprising:

a vertical shaft having a bridge extending radially therefrom, and

a blade attached pivotally to the bridge at a position offset from the shaft and depending therefrom.

The blade typically pivots about an axis that extends at right angles to the vertical shaft.

Preferably the blade is biased toward an in-use depending position.

Typically the paddle comprises a leaf spring extending from the blade and engaging with the bridge.

There is typically a pair of said blades at diametrically opposite positions of the bridge.

### BRIEF DESCRIPTION OF THE DRAWINGS

A preferred form of the present intention will now be described by way of example with reference to the accompanying drawings, wherein:

FIG. 1 is a schematic plan view of a mixing cooker,

FIG. 2 is a schematic cross-sectional elevational view or the mixing cooker of FIG. 1,

FIG. 3 is a schematic elevational view of a mixing paddle,

FIG. 4 is a schematic side elevational view of the mixing paddle of FIG. 3,

FIG. 5 is a schematic plan view of the mixing paddle of FIGS. 3 and 4,

FIG. 6 is a schematic elevational view of the mixing paddle of FIGS. 3 to 5 showing one blade pushed inwardly,

FIG. 7 is a schematic cross-sectional elevational view of the mixing paddle of FIG. 6,

FIG. 8 is a schematic cross-sectional elevational view similar to FIG. 7, but showing a pair of snap-on blades,

FIG. 9 is a schematic perspective view of a double-helix worm and worm follower, and

FIG. 10 is a schematic perspective view of the worm and worm follower of FIG. 9 showing details of the follower's tongue for receipt within the helical groove of the worm.

### DESCRIPTION OF THE PREFERRED EMBODIMENT

In the accompanying drawings there is depicted schematically a mixing cooker 10. The cooker 10 comprises a base 5 typically made of metal and upon which there is supported a track casing 2, The base 5 also supports a heater 14, which in turn supports a skillet 6.

Within the track casing 2 there is mounted a pair of parallel and coextensive guide rails 9 between which there is located an elongate worm 3. The guide rails would be supported at their respective ends by appropriate bearings within the track casing 2. The worm 3 is driven to rotate by a carriage motor 1 and would be supported at its other end by an appropriate bearing.

A carriage 4 is mounted on the guide rails 9. The carriage has a pair of parallel apertures 15 through which the respective guide rails pass. The carriage 4 also has an aperture 16 through which the worm 3 passes.

The worm might have a single helical groove 17 into within a pin extending from the carriage 4 and within the aperture 16 is received.

Upon activation of carriage motor 1, the worm 3 rotates. As a result, the carriage 4 will traverse back or forth along the guide rails 9 in one of two opposite directions depending upon the rotational direction of the worm 3. When the carriage approaches one end of the track casing, a micro-switch or sensor (one and each end of the track casing) can trigger the carriage motor to reverse so that the carriage will move in the opposite direction.

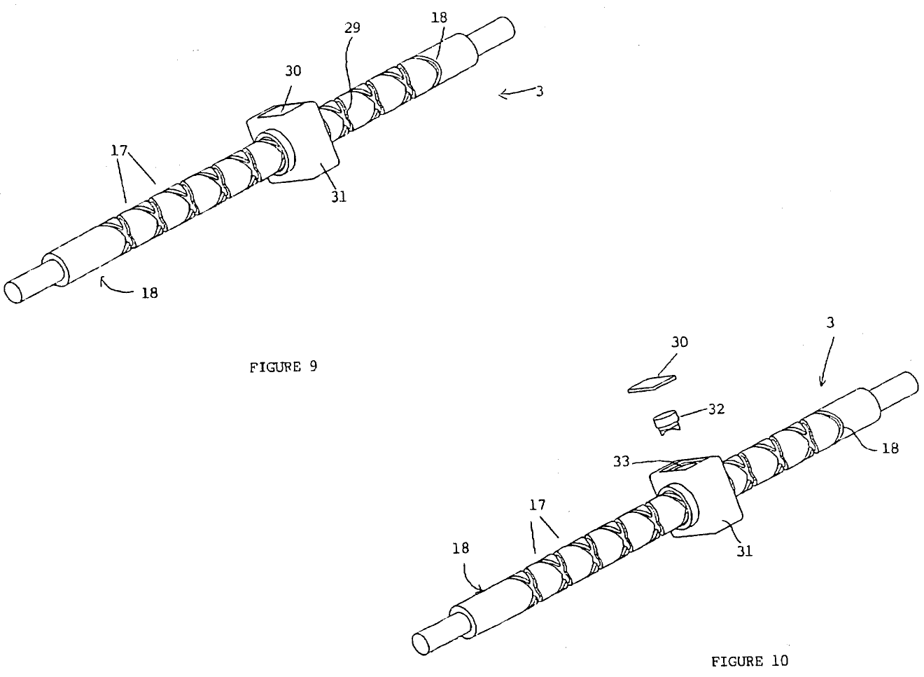

As an alternative, and as shown in FIGS. 9 and 10, the worm 3 might have its helical groove 17 double back and crisscross upon itself so that it can rotate continuously in one direction, without the need to reverse the carriage motor or provide micro-switches to trigger such reversal. Instead, at each turning curve of the worm 3, the helical groove 17 would be provided with a turning curve 18 within which the tongue that extends from the carriage travels. The helical groove is in fact formed as a single groove that criss-crosses over itself at crossing points 29. There is a worm follower 31 through which the worm 3 passes. The worm follower mounts within the carriage 4. The worm follower 31 has a transverse circular aperture 33 within which there is loaded a tongue disc 32 having a tongue that is received within the groove 17′. The tongue disc can rotate within the circular aperture 33. There is a cover plate 30 to retain the tongue disc 32 in place within the worm follower 31. The tongue acts somewhat like the tongue of a slot car and is shaped to prevent inadvertent jamming against the crossing points 29 of the helical groove 17.

Further, whilst the tongue should be sufficiently long to pass smoothly across the crossing points 29, it is not so long as to foul or jam within the turning curves 18 at each end of the worm during which time the tongue disc pilots within the circular aperture 33.

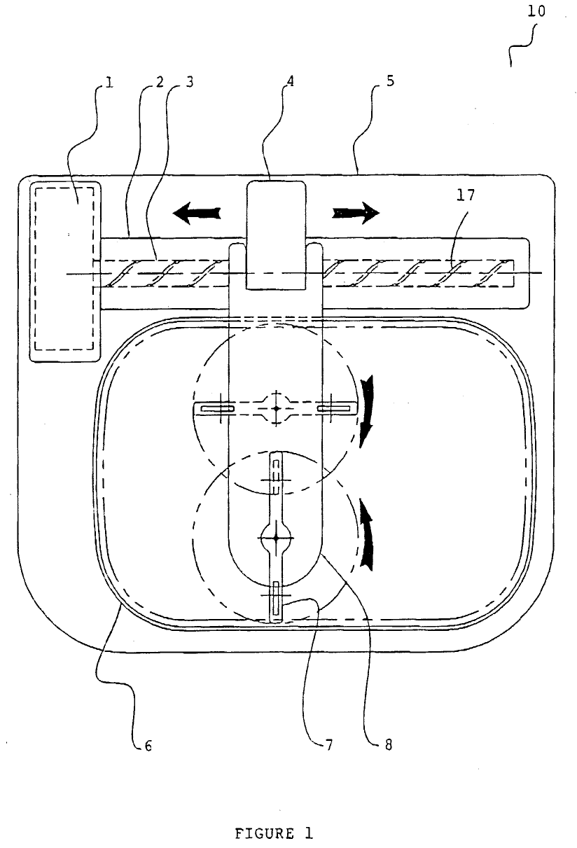

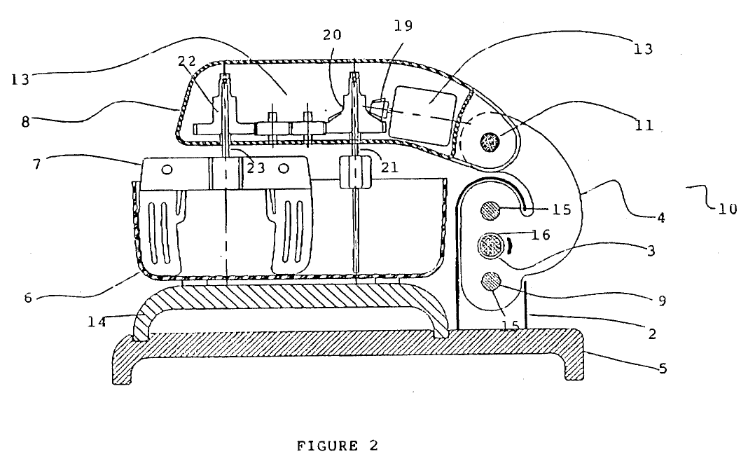

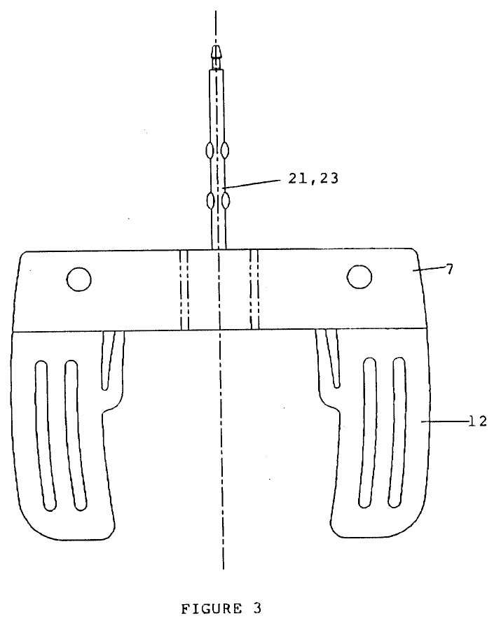

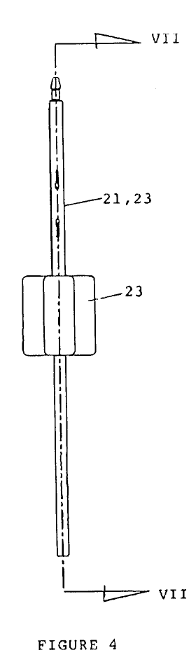

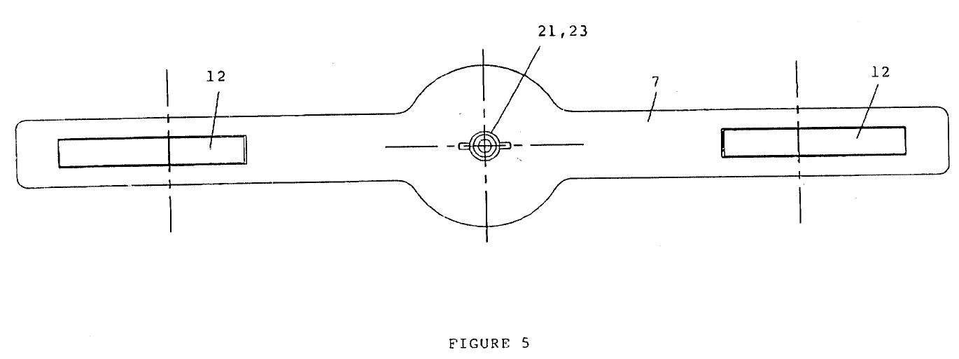

Attached pivotally at pivot pin 11 to the carriage 4 is an arm 8 from which there depends a pair of paddles 12. There is a paddle motor 13 located within the arm 8 and its output pinion 19 drives a gear 20. A shaft 21 is removably attached to the gear 20 and depends from the arm to support one of the paddles. There is a gear train 13 between the gear 20 and another gear 22. Like gear 20, the gear 22 has a removable shaft 23 depending from the arm to support another paddle. Upon activation of paddle motor 13, the two paddles counter-rotate as shown by the arrows in FIG. 1.

Electric power is delivered to the motor 13 by one of several alternative methods. One method is to use the guide rails 9 and 15 as conductors and adopt a brush style pick-up. However, this could be dangerous and problematic, so another method is to use a cable that is laid in a track all groove such that the fixed end he said one end of the carriage's travel with a cable adopting a U-shape, and that the other end of travel the cable is straight. Such a cable might have a flat or circular cross-section, or might be provided as a flex-PDB having elongate conductive tracks.

Each paddle comprises a bridge 7 attached to the shaft 21, 23. The bridge extends in a diametrically fashion and has pivotally affixed at each remote end a blade 12. The bridge 7 is to be fabricated from a strong material such as metal or hard plastics. The shaft 21, 23 includes an anchor sprocket 23 received within the bridge 7 to ensure that the bridge 7 rotates upon rotation of the shaft.

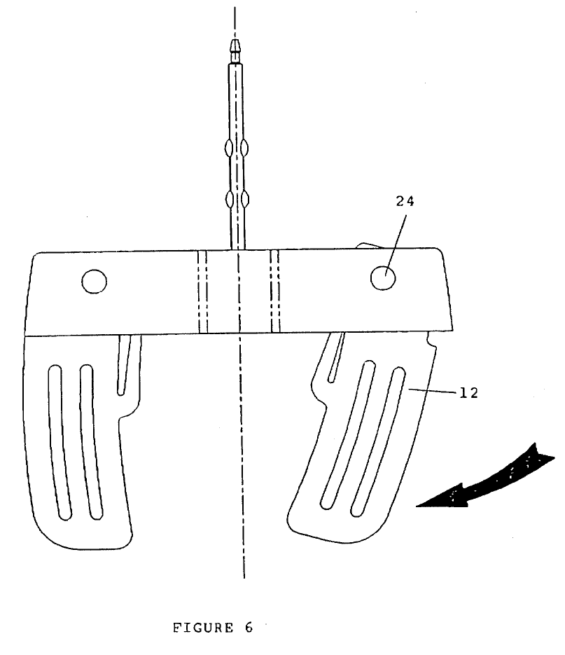

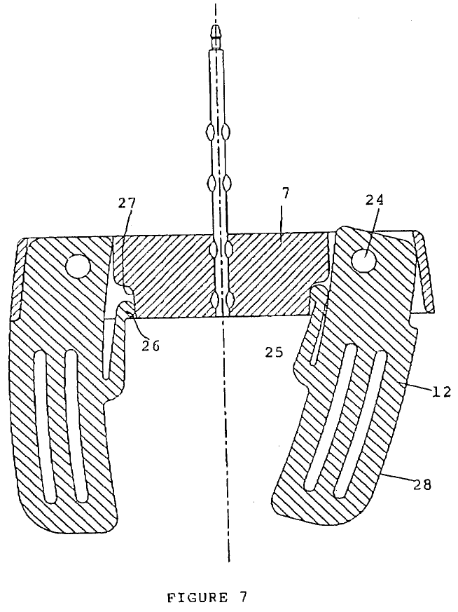

Each blade 12 is typically fabricated from an elastic material such as plastics. As shown in FIGS. 6 and 7, each blade 12 can pivot about a pivot pin 24 and includes an integral leaf spring 25. Each leaf spring comprises a rounded end 26 that bears against a bearing surface 27 of the arm 7. The blades 12 have a contoured outer edge 28 that conforms to be inside surface of the skillet 6, Should a blade 12 encounter a hard object such as a bone, the blade can yield as shown by the arrow in FIG. 6. To this end, the leaf spring 25 deforms as the rounded end 26 bears against the bearing surface 27.

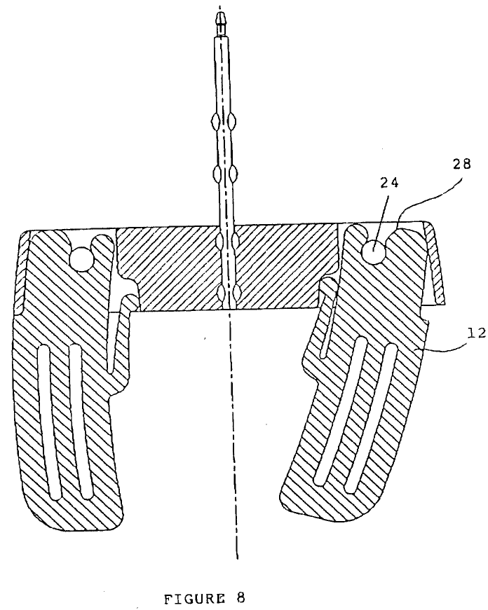

In order to facilitate cleaning, and as shown in FIG. 8, each leaf spring 12 might be provided with an appropriately shaped recess 28 for snap-engagement with and removal from the pivot pin 24.

In use, electricity is applied upon activation of a switch (not shown) to the heating plate 14 to beat the contents of the skillet 6. Another switch (also not shown) can then be pressed to activate carriage motor 1 and paddle motor 13 to thereby result in linear reciprocation of the carriage 4 and arm 8 and counter rotation of the paddles. As a result, the paddles will encounter the entire contents of the skillet, thereby providing for a mixing and preventing burning of the skillet contents during cooking.

It should be appreciated that modifications and alterations obvious to those skilled in the art are not to he considered as beyond the scope of the present invention. For example, instead of mounting the arm 2 pivotally with respect to the carriage 4, the carriage itself and even the track casing 2 might be pivotable with respect to the base 5. Also, instead of providing manually activated switches, a pre-set or user-programmable sequence could be used for activating stirring, heating and traversing.

Furthermore, the paddle motor could be positioned remotely in the traverse motor enclosure. A long splined or geared shaft (adjacent and parallel to the worm) could provide the means for taking off power to the carriage and to the mixing blades. Alternatively a fixed geared rack running parallel with the worm could engage with a gear in the carriage, transferring motion to the mixing blade gears and deriving motion through the lateral displacement of the carriage due to the action of the worm.

Also, the worm and guide rails could be mounted centrally above the cooking vessel and the complete arm and worm assembly then pivoted upwardly at the traverse motor to provide clearance for removal of the vessel.

Further, the device is not limited to the mixing blades illustrated and could use different mixing blade configurations and actions to provide different styles of mixing. For instance the blades could be whisk-like or could be similar to conventional beaters. They could have a planetary action or they could comprise a horizontal bar configured to skim the surface of ingredients in the vessel and ensure that food located at the bottom of the vessel is not burnt and that the stirring action does not convert the food into mush.

Furthermore, whilst in the preferred embodiment, a “T” shaped follower is used to prevent inadvertent engagement with the crossing helix, another arrangement might use a half nut for each direction of travel. In such a system, only one half nut is engaged at any given time. The change-over would occur at each end of travel, by a spring loaded snap-acting ramp arrangement that disengages one half nut from one helix and engages the other in the other helix.

1. An apparatus for stirring ingredients, comprising:
a base,
a receptacle supported by the base for receiving the ingredients,
a track mounted to the base,
a carriage conveyed along the track,
an arm extending from the carriage over the receptacle, and
a driven paddle depending from the arm into the receptacle.

2. The apparatus of claim 1 wherein the carriage is pivotable upon the track.

3. The apparatus of claim 1 comprising a carriage motor and wherein the track comprises a pair of elongate parallel and substantially coextensive rails passing through corresponding apertures in the carriage and there is an elongate worm parallel with the rails and driven to rotate by the carriage motor and the carriage comprises a worm follower engaging with the worm.

4. The apparatus of claim 3 wherein the worm comprises a helical thread with which the worm follower engages.

5. The apparatus of claim 4 wherein rotational output of the carriage motor reverses.

6. The apparatus of claim 4 wherein the carriage motor rotates in one direction only and the helical thread of the worm reverses and criss-crosses upon itself.

7. The apparatus of claim 1 further comprising a paddle motor in the arm driving the paddle.

8. The apparatus of claim 7 comprising a further paddle also driven by the paddle motor.

9. The apparatus of claim 8 wherein both said paddles are substantially identical and overlap with one another.

10. The apparatus of claim 1 wherein the receptacle is substantially rectangular when viewed in plan, but with curved corners to accommodate the paddles.

11. The apparatus of claim 1 wherein the paddle comprises a bridge extending diametrically from a vertical shaft and from which a pair of blades depend.

12. The apparatus of claim 11 wherein each blade is attached pivotally to the bridge.

13. The apparatus of claim 12 wherein each blade is snap-engaged to the bridge.

14. The apparatus of claim 11 wherein the blades are adapted to pivot toward one another.

15. The apparatus of claim 12 wherein the blades are spring-biased into an in-use configuration.

16. The apparatus of claim 15 wherein the blades comprise an integral leaf spring that bears against the bridge.

17. The apparatus of claim 8 wherein one of said paddles extends from a gear driven by an output gear of the paddle motor and the other paddle extends from a gear and wherein there is a gear train between these two gears.

18. The apparatus of claim 1 further comprising a heater heating the receptacle and supported by the base.

19. A stirring paddle for a food stirring apparatus, comprising:
vertical shaft having a bridge extending radially therefrom, and
a blade attached pivotally to the bridge at a position offset from the shaft and depending therefrom.

20. The stirring paddle of claim 19 wherein the blade pivots about an axis that extends at right angles to the vertical shaft.

21. The stirring paddle of claim 18 wherein the blade is biased toward an in-use depending position.

22. The stirring paddle of claim 21 comprising a leaf spring extending from the blade and engaging with the bridge.

24. The stirring paddle of claim 22 comprising a pair of said blades at diametrically opposed positions of the bridge.
